(19) United States
(12) Patent Application Publication
(10) Pub. No.: US 2006/0229753 A1
(43) Pub. Date: Oct. 12, 2006

(54) Probabilistic modeling system for product design

(75) Inventors: Michael Seskin, Cardiff, CA (US); Anthony J. Grichnik, Peoria, IL (US); Ben Kwok-kwong Tse, San Diego, CA (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/101,498

(22) Filed: Apr. 8, 2005

(51) Int. Cl. G06F 19/00

(52) U.S. Cl. 700/97

(57) ABSTRACT

A method for designing a product includes obtaining data records relating to one or more input variables and one or more output parameters associated with the product. One or more input parameters may be selected from the one or more input variables, and a computational model indicative of interrelationships between the one or more input parameters and the one or more output parameters based on the data records may be generated. The method further includes providing a set of constraints to the computational model representative of a compliance state for the product and using the computational model to generate statistical distributions for the one or more input parameters and the one or more output parameters, based on the set of constraints, that represent a design for the product.

### TECHNICAL FIELD

This disclosure relates generally to product design systems and, more particularly, to probabilistic design based modeling systems for use in product design applications.

### BACKGROUND

Many computer-based applications exist for aiding in the design of products. Using these applications, an engineer can construct a computer model of a particular product and can analyze the behavior of the product through various analysis techniques. Further, certain analytical tools have been developed that enable engineers to evaluate and test multiple design configurations of a product. While these analytical tools may include internal optimization algorithms to provide this functionality, these tools generally represent only domain specific designs. Therefore, while product design variations can be tested and subsequently optimized, these design variations are typically optimized with respect to only a single requirement within a specific domain.

Finite element analysis (FEA) applications may fall into this domain specific category. With FEA applications, an engineer can test various product designs against requirements relating to stress and strain, vibration response, modal frequencies, and stability. Because the optimizing algorithms included in these FEA applications can optimize design parameters only with respect to a single requirement, however, multiple design requirements must be transformed into a single function for optimization. For example, in FEA analysis, one objective may be to parameterize a product design such that stress and strain are minimized. Because the FEA software cannot optimize both stress and strain simultaneously, the stress and strain design requirements may be transformed into a ratio of stress to strain (i.e., the modulus of elasticity). In the analysis, this ratio becomes the goal function to be optimized.

Several drawbacks result from this approach. For example, because more than one output requirement is transformed into a single goal function, the underlying relationships and interactions between the design parameters and the response of the product system are hidden from the design engineer. Further, based on this approach, engineers may be unable to optimize their designs according to competing requirements.

Thus, there is a need for modeling and analysis applications that can establish heuristic models between design inputs and outputs, subject to defined constraints, and optimize the inputs such that the probability of compliance of multiple competing outputs is maximized. Further, there is a need for applications that can explain the causal relationship between design inputs and outputs.

Certain applications have been developed that attempt to optimize design inputs based on multiple competing outputs. For example, U.S. Pat. No. 6,086,617 (“the '617 patent”) issued to Waldon et al. on Jul. 11, 2000, describes an optimization design system that includes a directed heuristic search (DHS). The DHS directs a design optimization process that implements a user's selections and directions. The DHS also directs the order and directions in which the search for an optimal design is conducted and how the search sequences through potential design solutions.

While the optimization design system of the '617 patent may provide a multi-disciplinary solution for product design optimization, this system has several shortcomings. The efficiency of this system is hindered by the need to pass through slow simulation tools in order to generate each new model result. Further, there is no knowledge in the system model of how variation in the input parameters relates to variation in the output parameters. The system of the '617 patent provides only single point solutions, which may be inadequate especially where a single point optimum may be unstable when subject to variability introduced by a manufacturing process or other sources. Further, the system of the '617 patent is limited in the number of dimensions that can be simultaneously optimized and searched.

The disclosed systems are directed to solving one or more of the problems set forth above.

### SUMMARY OF THE INVENTION

One aspect of the present disclosure includes a method for designing a product. The method includes obtaining data records relating to one or more input variables and one or more output parameters associated with the product. One or more input parameters may be selected from the one or more input variables, and a computational model indicative of interrelationships between the one or more input parameters and the one or more output parameters based on the data records may be generated. The method further includes providing a set of constraints to the computational model representative of a compliance state for the product and using the computational model to generate statistical distributions for the one or more input parameters and the one or more output parameters, based on the set of constraints, that represent a design for the product.

Another aspect of the present disclosure includes a computer readable medium. The computer readable medium includes a set of instructions for enabling a processor to obtain data records relating to one or more input variables and one or more output parameters associated with a product to be designed. Instructions may also be included that enable the processor to select one or more input parameters from the one or more input variables, generate a computational model indicative of interrelationships between the one or more input parameters and the one or more output parameters based on the data records, and obtain a set of constraints representative of a compliance state for the product. Based on other instructions, the processor may use the computational model to generate statistical distributions for the one or more input parameters and the one or more output parameters, based on the set of constraints, that represent a design for the product.

Yet another aspect of the present disclosure includes a computer-based product design system. This system may include a database containing data records relating one or more input variables and one or more output parameters associated with a product to be designed. A processor may be included and configured to select one or more input parameters from the one or more input variables and generate a computational model indicative of interrelationships between the one or more input parameters and the one or more output parameters based on the data records. The processor may also be configured to obtain a set of constraints representative of a compliance state for the product and use the computational model to generate statistical distributions for the one or more input parameters and the one or more output parameters, based on the set of constraints, that represent a design for the product.

### BRIEF DESCRIPTION OF THE DRAWINGS

FIG. 1 is a block diagram representation of a product design system according to an exemplary disclosed embodiment.

FIG. 2 is a flow chart representing an exemplary disclosed method for designing a product.

### DETAILED DESCRIPTION

Reference will now be made in detail to exemplary embodiments, which are illustrated in the accompanying drawings. Wherever possible, the same reference numbers will be used throughout the drawings to refer to the same or like parts.

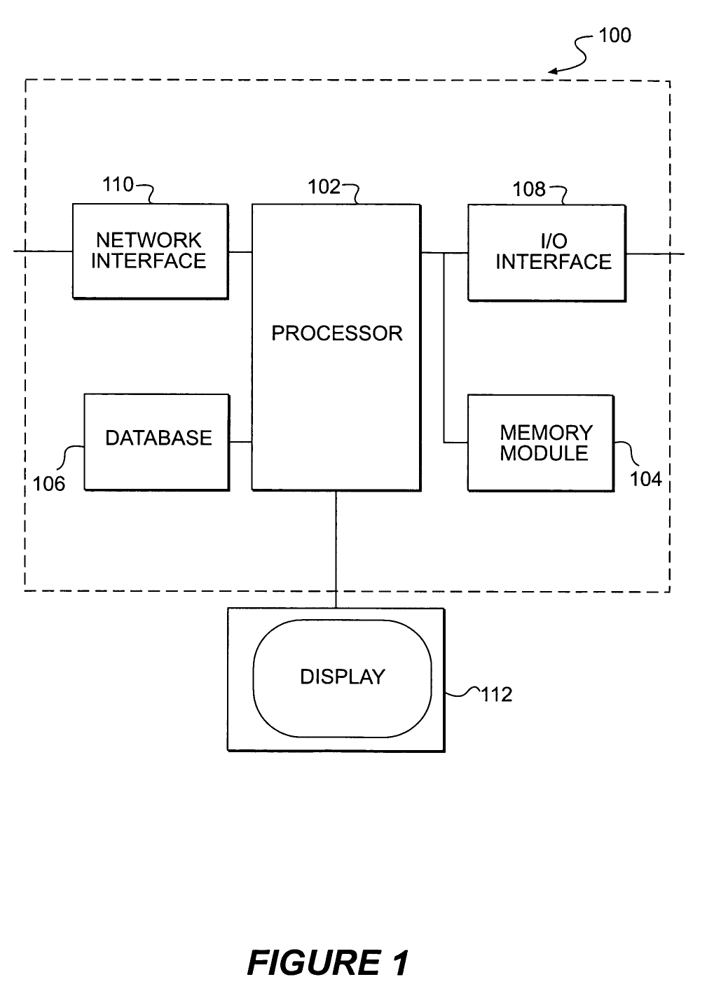

FIG. 1 provides a block diagram representation of a product design system 100 for generating a design of a product. A product may refer to any entity that includes at least one part or component. A product may also refer to multiple parts assembled together to form an assembly. Non-limiting examples of products include work machines, engines, automobiles, aircraft, boats, appliances, electronics, and any sub-components, sub-assemblies, or parts thereof.

A product design may be represented as a set of one or more input parameter values. These parameters may correspond to dimensions, tolerances, moments of inertia, mass, material selections, or any other characteristic affecting one or more properties of the product. The disclosed product design system 100 may be configured to provide a probabilistic product design such that one or more input parameters can be expressed as nominal values and corresponding statistical distributions. Similarly, the product design may include nominal values for one or more output parameters and corresponding statistical distributions. The statistical distributions of the output parameters may provide an indication of the probability that the product design complies with a desired set of output requirements.

Product design system 100 may include a processor 102, a memory module 104, a database 106, an I/O interface 108, and a network interface 110. Product design system 100 may also include a display 112. Any other components suitable for receiving and interacting with data, executing instructions, communicating with one or more external workstations, displaying information, etc. may also be included in product design system 100.

Processor 102 may include any appropriate type of general purpose microprocessor, digital signal processor, or microcontroller. Memory module 104 may include one or more memory devices including, but not limited to, a ROM, a flash memory, a dynamic RAM, and a static RAM. Memory module 104 may be configured to store information accessed and used by processor 102. Database 106 may include any type of appropriate database containing information relating to characteristics of input parameters, output parameters, mathematical models, and/or any other control information. I/O interface 108 may be connected to various data input devices (e.g., keyboards, pointers, drawing tablets, etc.)(not shown) to provide data and control information to product design system 100. Network interface 110 may include any appropriate type of network adaptor capable of communicating with other computer systems based on one or more communication protocols. Display 112 may include any type of device (e.g., CRT monitors, LCD screens, etc.) capable of graphically depicting information.

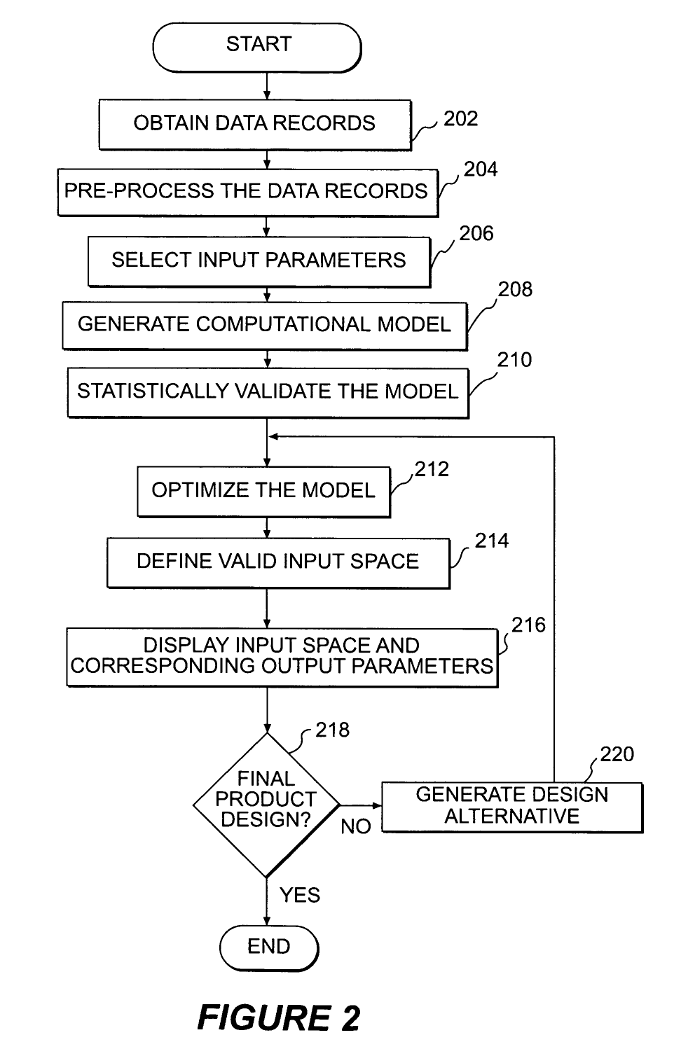

FIG. 2 provides a flow chart representing an exemplary disclosed method for designing a product using product design system 100. At step 202, product design system may obtain data records relating to input variables and output parameters associated with a product to be designed. The data records may reflect characteristics of the input parameters and output parameters, such as statistical distributions, normal ranges, and/or tolerances, etc. For each data record, there may be a set of output parameter values that corresponds to a particular set of input variable values. The data records may represent pre-generated data that has been stored, for example, in database 106. The data may be computer generated or empirically collected through testing of actual products.

In one embodiment, the data records may be generated in the following manner. For a particular product to be designed, a design space of interest may be identified. A plurality of sets of random values may be generated for various input variables that fall within the desired product design space. These sets of random values may be supplied to at least one simulation algorithm to generate values for one or more output parameters related to the input variables. The at least one simulation algorithm may be associated with, for example, systems for performing finite element analysis, computational fluid dynamics analysis, radio frequency simulation, electromagnetic field simulation, electrostatic discharge simulation, network propagation simulation, discrete event simulation, constraint-based network simulation, or any other appropriate type of dynamic simulation.

At step 204, which may be optional, the data records may be pre-processed. Processor 102 may pre-process the data records to clean up the data records for obvious errors and to eliminate redundancies. Processor 102 may remove approximately identical data records and/or remove data records that are out of a reasonable range in order to be meaningful for model generation and optimization. For randomly generated data records, any cases violating variable covariance terms may be eliminated. After the data records have been pre-processed, processor 102 may then select proper input parameters at step 206 by analyzing the data records.

The data records may include many input variables. In certain situations, for example, where the data records are obtained through experimental observations, the number of input variables may exceed the number of the data records and lead to sparse data scenarios. In these situations, the number of input variables may need to be reduced to create mathematical models within practical computational time limits and that contain enough degrees of freedom to map the relationship between inputs and outputs. In certain other situations, however, where the data records are computer generated using domain specific algorithms, there may be less of a risk that the number of input variables exceeds the number of data records. That is, in these situations, if the number of input variables exceeds the number of data records, more data records may be generated using the domain specific algorithms. Thus, for computer generated data records, the number of data records can be made to exceed, and often far exceed, the number of input variables. For these situations, the input parameters selected for use in step 206 may correspond to the entire set of input variables.

Where the number on input variables exceeds the number of data records, and it would not be practical or cost-effective to generate additional data records, processor 102 may select input parameters at step 206 according to predetermined criteria. For example, processor 102 may choose input parameters by experimentation and/or expert opinions. Alternatively, in certain embodiments, processor 102 may select input parameters based on a mahalanobis distance between a normal data set and an abnormal data set of the data records. The normal data set and abnormal data set may be defined by processor 102 by any suitable method. For example, the normal data set may include characteristic data associated with the input parameters that produce desired output parameters. On the other hand, the abnormal data set may include any characteristic data that may be out of tolerance or may need to be avoided. The normal data set and abnormal data set may be predefined by processor 102.

Mahalanobis distance may refer to a mathematical representation that may be used to measure data profiles based on correlations between parameters in a data set. Mahalanobis distance differs from Euclidean distance in that mahalanobis distance takes into account the correlations of the data set. Mahalanobis distance of a data set X (e.g., a multivariate vector) may be represented as
MDᵢ=(Xᵢ−μₓ)Σ⁻¹(Xᵢ−μₓ)′ (1)
where μₓ is the mean of X and Σ⁻¹ is an inverse variance-covariance matrix of X. MDᵢ weights the distance of a data point Xᵢ from its mean μₓ such that observations that are on the same multivariate normal density contour will have the same distance. Such observations may be used to identify and select correlated parameters from separate data groups having different variances.

Processor 102 may select a desired subset of input parameters such that the mahalanobis distance between the normal data set and the abnormal data set is maximized or optimized. A genetic algorithm may be used by processor 102 to search the input parameters for the desired subset with the purpose of maximizing the mahalanobis distance. Processor 102 may select a candidate subset of the input parameters based on a predetermined criteria and calculate a mahalanobis distance MDₙₒᵣₘₐₗ of the normal data set and a mahalanobis distance MD_{abnormal} of the abnormal data set. Processor 102 may also calculate the mahalanobis distance between the normal data set and the abnormal data (i.e., the deviation of the mahalanobis distance MDₓ=MDₙₒᵣₘₐₗ−MDₙₒᵣₘₐₗ). Other types of deviations, however, may also be used.

Processor 102 may select the candidate subset of the input parameters if the genetic algorithm converges (i.e., the genetic algorithm finds the maximized or optimized mahalanobis distance between the normal data set and the abnormal data set corresponding to the candidate subset). If the genetic algorithm does not converge, a different candidate subset of the input parameters may be created for further searching. This searching process may continue until the genetic algorithm converges and a desired subset of the input parameters is selected.

After selecting input parameters, processor 102 may generate a computational model to build interrelationships between the input parameters and output parameters (step 208). Any appropriate type of neural network may be used to build the computational model. The type of neural network models used may include back propagation, feed forward models, cascaded neural networks, and/or hybrid neural networks, etc. Particular types or structures of the neural network used may depend on particular applications. Other types of models, such as linear system or non-linear system models, etc., may also be used.

The neural network computational model may be trained by using selected data records. For example, the neural network computational model may include a relationship between output parameters (e.g., engine power, engine efficiency, engine vibration, etc.) and input parameters (e.g., cylinder wall thickness, cylinder wall material, cylinder bore, etc). The neural network computational model may be evaluated by predetermined criteria to determine whether the training is completed. The criteria may include desired ranges of accuracy, time, and/or number of training iterations, etc.

After the neural network has been trained (i.e., the computational model has initially been established based on the predetermined criteria), processor 102 may statistically validate the computational model (step 210). Statistical validation may refer to an analyzing process to compare outputs of the neural network computational model with actual outputs to determine the accuracy of the computational model. Part of the data records may be reserved for use in the validation process. Alternatively, processor 102 may generate simulation or test data for use in the validation process.

Once trained and validated, the computational model may be used to determine values of output parameters when provided with values of input parameters. Further, processor 102 may optimize the model by determining desired distributions of the input parameters based on relationships between the input parameters and desired distributions of the output parameters (step 212).

Processor 102 may analyze the relationships between distributions of the input parameters and desired distributions of the output parameters (e.g., design constraints provided to the model that may represent a state of compliance of the product design). Processor 102 may then run a simulation of the computational model to find statistical distributions for an individual input parameter. That is, processor 102 may separately determine a distribution (e.g., mean, standard variation, etc.) of the individual input parameter corresponding to the ranges of the output parameters representing a compliance state for the product. Processor 102 may then analyze and combine the desired distributions for all the individual input parameters to determined desired distributions and characteristics for the input parameters.

Alternatively, processor 102 may identify desired distributions of input parameters simultaneously to maximize the probability of obtaining desired outcomes (i.e., to maximize the probability that a certain product design is compliant with the desired requirements). In certain embodiments, processor 102 may simultaneously determine desired distributions of the input parameters based on zeta statistic. Zeta statistic may indicate a relationship between input parameters, their value ranges, and desired outcomes. Zeta statistic may be represented as

$$ζ = {\sum }_{1}^{j} {\sum }_{1}^{i} \vert {S}_{ij} \vert ( \frac{{σ}_{i}}{ {\overline{x}}_{i}} ) ( \frac{ {\overline{x}}_{j}}{{σ}_{j}} ) ,$$

where \overline{x}ᵢ represents the mean or expected value of an ith input; \overline{x}ⱼ represents the mean or expected value of a jth outcome; σᵢ represents the standard deviation of the ith input; σⱼ represents the standard deviation of the jth outcome; and |Sᵢⱼ| represents the partial derivative or sensitivity of the jth outcome to the ith input.

Processor 102 may identify a desired distribution of the input parameters such that the zeta statistic of the neural network computational model is maximized or optimized. A genetic algorithm may be used by processor 102 to search the desired distribution of input parameters with the purpose of maximizing the zeta statistic. Processor 102 may select a candidate set of input parameters with predetermined search ranges and run a simulation of the product design model to calculate the zeta statistic parameters based on the input parameters, the output parameters, and the neural network computational model. Processor 102 may obtain \overline{x}ᵢ and σᵢ by analyzing the candidate set of input parameters, and obtain \overline{x}ⱼ and σⱼ by analyzing the outcomes of the simulation. Further, processor 102 may obtain |Sᵢⱼ| from the trained neural network as an indication of the impact of ith input on the jth outcome.

Processor 102 may select the candidate set of input parameters if the genetic algorithm converges (i.e., the genetic algorithm finds the maximized or optimized zeta statistic of the product design model corresponding to the candidate set of input parameters). If the genetic algorithm does not converge, a different candidate set of input parameters may be created by the genetic algorithm for further searching. This searching process may continue until the genetic algorithm converges and a desired set of the input parameters is identified. Processor 102 may further determine desired distributions (e.g., mean and standard deviations) of input parameters based on the desired input parameter set.

After the product design model has been optimized (step 212), processor 102 may define a valid input space (step 214) representative of an optimized design of the product. This valid input space may represent the nominal values and corresponding statistical distributions for each of the selected input parameters. To implement the design of the product, values for the input parameters selected within the valid input space would maximize the probability of achieving a compliance state according to the constraints provided to the model.

Once the valid input space has been determined, this information may be provided to display 112. Along with the input space information, the nominal values of the corresponding output parameters and the associated distributions may also be supplied to display 112. Displaying this information conveys to the product design engineer the ranges of values for the selected input parameters that are consistent with the optimized product design. This information also enables the engineer to determine the probability of compliance of any one of or all of the output parameters in the optimized product design.

While the processor 102 may be configured to provide an optimized product design based on the interrelationships between the selected input parameters and the output parameters and on the selected output constraints, the model allows for additional input by the product design engineer. Specifically, at step 218, the engineer is allowed to determine if the optimized product design generated by processor 102 represents the desired final design. If the answer is yes (step 218, yes), then the process ends. If the answer is no (step 218, no) the engineer can generate a design alternative (step 220).

To generate a design alternative, the engineer can vary any of the values of the input parameters or the distributions associated with the input parameters. The changed values may be supplied back to the simulation portion of the model for reoptimization. Based on the changed values, the model will display updated values and distributions for the output parameters changed as a result of the change to the input parameters. From the updated information, the engineer can determine how the alternative product design impacts the probability of compliance. This process can continue until the engineer decides on a final product design. It should be noted that alternative designs may also be generated by varying the values or distributions for the output parameters or by defining different or additional product design constraints.

Display 112 may also be used to display statistical information relating to the performance of the product design model. For example, distributions for the input parameters and the output parameters may be calculated based on the original data records. These distributions may represent an actual statistical space that can be compared with a predicted statistical space generated by the model. Overlap of the actual statistical space with the predicted statistical space may indicate that the model is functioning as expected.

### INDUSTRIAL APPLICABILITY

The disclosed systems and methods may efficiently provide optimized product designs for any type of product that can be modeled by computer. Based on the disclosed system, complex interrelationships may be analyzed during the generation of computational models to optimize the models by identifying distributions of input parameters to the models to obtain desired outputs. The robustness and accuracy of product designs may be significantly improved by using the disclosed systems and methods.

The efficiency of designing a product may also be improved using the disclosed systems and methods. For example, the disclosed zeta statistic approach yields knowledge of how variation in the input parameters translates to variation in the output parameters. Thus, by defining the interrelationships between the input parameters and the output parameters in a system, the disclosed product design system can operate based on a proxy concept. That is, because these interrelationships are known and modeled, there is no need to use domain specific algorithm tools each time the model wishes to explore the effects of a variation in value or distribution of an input parameter or output parameter. Thus, unlike traditional systems that must pass repeatedly pass through slow simulations as part of a design optimization process, the disclosed modeling system takes advantage of well-validated models (e.g., neural network models) in place of slow simulations to more rapidly determine an optimized product design solution.

The disclosed product design system can significantly reduce the cost to manufacture a product. Based on the statistical output generated by the model, the model can indicate the ranges of input parameter values that can be used to achieve a compliance state. The product design engineer can exploit this information to vary certain input parameter values without significantly affecting the compliance state of the product design. That is, the manufacturing constraints for a particular product design may be made less restrictive without affecting (or at least significantly affecting) the overall compliance state of the design. Relaxing the manufacturing design constraints can simplify the manufacturing process for the product, which can lead to manufacturing cost savings.

The disclosed product design system can also enable a product design engineer to explore “what if” scenarios based on the optimized model. Because the interrelationships between input parameters and output parameters are known and understood by the model, the product designer can generate alternative designs based on the optimized product design to determine how one or more individual changes will affect the probability of compliance. While these design alternatives may move away from the optimized product design solution, this feature of the product design system can enable a product designer to adjust the design based on experience. Specifically, the product designer may recognize areas in the optimized model where certain manufacturing constraints may be relaxed to provide a cost savings, for example. By exploring the effect of the alternative design on product compliance probability, the designer can determine whether the potential cost savings of the alternative design would outweigh a potential reduction in probability of compliance.

The disclosed product design system has several other advantages. For example, the use of genetic algorithms at various stages in the model avoids the need for a product designer to define the step size for variable changes. Further, the model has no limit to the number of dimensions that can be simultaneously optimized and searched.

Other embodiments, features, aspects, and principles of the disclosed exemplary systems will be apparent to those skilled in the art and may be implemented in various environments and systems.

What is claimed is:

1. A method for designing a product, comprising:
obtaining data records relating to one or more input variables and one or more output parameters associated with the product;
selecting one or more input parameters from the one or more input variables;
generating a computational model indicative of interrelationships between the one or more input parameters and the one or more output parameters based on the data records;
providing a set of constraints to the computational model representative of a compliance state for the product; and
using the computational model to generate statistical distributions for the one or more input parameters and the one or more output parameters, based on the set of constraints, that represent a design for the product.

2. The method according to claim 1, wherein obtaining the data records includes:
generating a plurality of sets of random values for the one or more input variables representative of a desired product design space;
supplying each of the plurality of sets of random values to at least one simulation algorithm to generate values for the one or more output parameters.

3. The method of claim 2, wherein the at least one simulation algorithm is associated with a system for performing at least one of finite element analysis, computational fluid dynamics analysis, radio frequency simulation, electromagnetic field simulation, electrostatic discharge simulation, network propagation simulation, discrete event simulation, constraint-based network simulation.

4. The method of claim 1, further including using the computation model to generate nominal values for the one or more input parameters and the one or more output parameters.

5. The method of claim 4, further including modifying the design for the product by adjusting at least one of the statistical distributions and the nominal values for any of the one or more input parameters and the one or more output parameters.

6. The method of claim 1, wherein the selecting further includes:
pre-processing the data records; and
using a genetic algorithm to select the one or more input parameters from the one or more input variables based on a mahalanobis distance between a normal data set and an abnormal data set of the data records.

7. The method of claim 1, wherein generating the computational model includes:
creating a neural network computational model;
training the neural network computational model using the data records; and
validating the neural network computation model using the data records.

8. The method of claim 1, wherein using the computational model to generate statistical distributions further includes:
determining a candidate set of input parameters with a maximum zeta statistic using a genetic algorithm; and
determining the statistical distributions of the one or more input parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{ {\overline{x}}_{i}} ) ( \frac{ {\overline{x}}_{j}}{{σ}_{j}} ) ,$$
provided that \overline{x}ᵢ represents a mean of an ith input; \overline{x}ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

9. The method of claim 1, further including graphically displaying on a display:
the statistical distributions for the one or more input parameters and the one or more output parameters; and
nominal values for the one or more input parameters and the one or more output parameters.

10. The method of claim 9, further including graphically displaying on the display:
statistical information for the one or more input parameters and the one or more output parameters obtained based on the data records.

11. A computer readable medium including a set of instructions for enabling a processor to:
obtain data records relating to one or more input variables and one or more output parameters associated with a product to be designed;
select one or more input parameters from the one or more input variables;
generate a computational model indicative of interrelationships between the one or more input parameters and the one or more output parameters based on the data records;
obtain a set of constraints representative of a compliance state for the product; and
use the computational model to generate statistical distributions for the one or more input parameters and the one or more output parameters, based on the set of constraints, that represent a design for the product.

12. The computer readable medium of claim 11, wherein the instructions for enabling the processor to generate a computational model further enable the processor to:
create a neural network computational model;
train the neural network computational model using the data records; and
validate the neural network computation model using the data records.

13. The computer readable medium of claim 11, wherein the instructions for enabling the processor to use the computational model further enable the processor to:
determine a candidate set of input parameters with a maximum zeta statistic using a genetic algorithm; and
determine the statistical distributions of the one or more input parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{ {\overline{x}}_{i}} ) ( \frac{ {\overline{x}}_{j}}{{σ}_{j}} ) ,$$
provided that \overline{x}ᵢ represents a mean of an ith input; \overline{x}ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

14. The computer readable medium of claim 11 further including instructions for enabling the processor to graphically display:
the statistical distributions for the one or more input parameters and the one or more output parameters; and
nominal values for the one or more input parameters and the one or more output parameters.

15. The computer readable medium of claim 14, further including instructions for enabling the processor to graphically display:
statistical information for the one or more input parameters and the one or more output parameters obtained based on the data records.

16. A computer-based product design system, comprising:
a database containing data records relating one or more input variables and one or more output parameters associated with a product to be designed; and
a processor configured to:
select one or more input parameters from the one or more input variables;
generate a computational model indicative of interrelationships between the one or more input parameters and the one or more output parameters based on the data records;
obtain a set of constraints representative of a compliance state for the product; and
use the computational model to generate statistical distributions for the one or more input parameters and the one or more output parameters, based on the set of constraints, that represent a design for the product.

17. The computer-based product design system of claim 16, wherein to generate the computational model, the processor is further configured to:
create a neural network computational model;
train the neural network computational model using the data records; and
validate the neural network computation model using the data records.

18. The computer-based product design system of claim 16, wherein to use the computational model to generate statistical distributions, the processor is further configured to:
determine a candidate set of input parameters with a maximum zeta statistic using a genetic algorithm; and
determine the statistical distributions of the one or more input parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{ {\overline{x}}_{i}} ) ( \frac{ {\overline{x}}_{j}}{{σ}_{j}} ) ,$$
provided that \overline{x}ᵢ represents a mean of an ith input; \overline{x}ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

19. The computer-based product design system of claim 16, further including:
a display;
wherein the processor is configured to display the statistical distributions for the one or more input parameters and the one or more output parameters; and
nominal values for the one or more input parameters and the one or more output parameters.

20. The computer-based product design system of claim 19, wherein the processor is configured to display statistical information for the one or more input parameters and the one or more output parameters obtained based on the data records.
